(19) United States
(12) Patent Application Publication
(10) Pub. No.: US 2010/0017785 A1
(43) Pub. Date: Jan. 21, 2010

(54) METHOD FOR GENERATING A MACHINE-EXECUTABLE TARGET CODE FROM A SOURCE CODE, ASSOCIATED COMPUTER PROGRAM AND COMPUTER SYSTEM

(75) Inventor: Frank Volkmann, Nurnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, München (DE)

(21) Appl. No.: 12/520,671

(22) PCT Filed: Dec. 22, 2006
(86) PCT No.: PCT/DE06/02303

§ 371 Date: Jun. 22, 2009

(51) Int. Cl. G06F 9/44; G06F 17/00

(52) U.S. Cl. 717/106; 715/234

(57) ABSTRACT

The invention relates to a method for generating a target code that can be executed from a source code by computer, wherein a markup language is provided, the markup language having a first set of commands for generating templates and optionally a second set of commands for incorporating data records. Further, the input of the source code is carried out in the markup language, wherein templates to be generated are incorporated in the source code by means of the commands from the first set of commands, and wherein data records for the templates to be generated are incorporated in the source code by means of commands from the second set of commands. Further, at least one table is generated from the source code occurs by means of a project planning computer. The at least one table is translated by a server into a target code that can be executed by a client. The target code is then transmitted to the client, who can then display the target code via a browser. The invention allows a programmer to write a source code, in which templates can be incorporated via the commands, without the programmer having to deal with the programming paradigms for the templates.

The invention relates to a method for generating a machine-executable target code from a source code, a computer program product performing the method and a computer system implementing the method. The invention is used in particular with integrated systems (more commonly known as “embedded systems”).

Text-based markup languages, such as e.g. the HyperText Markup Language (HTML) or the Extensible Markup Language (XML), are used to generate internet and/or intranet pages. In said languages, content such as text, images and hyperlinks is displayed by means of a web browser. A source code written in a markup language is given a structure by the “marking up” of code sections with opening and closing tags. The source code can also be subdivided in terms of a static part and a dynamic part. The static part can define the layout of the internet page that is implemented by means of the source code or, by means of its color scheme, also reflect the corporate identity of the organization. In contrast hereto there is the dynamic part of the code, which is modified much more frequently than the static part and which is used, for example, in order to provide customer-specific or up-to-the-minute information on the internet page. Advertising banners, which are frequently encountered on internet pages, are a further example of dynamic code.

The static part is implemented here by direct programming with the aid of the aforementioned tags. The dynamic part is incorporated into the code by programming templates, a template in this case forming a master layout which can be filled with different (content) data.

Furthermore, the internet pages are created dynamically, e.g. using script languages such as ASP/ASP-net (active server pages) or PHP (Hypertext Preprocessor), with the result that the internet page is generated by execution of scripts. Providing a programming environment having a widely established script language is expensive and imposes heavy demands on the hardware in terms of resource requirements. If, however, the available resources are more modest, for example because the microprocessor is not very powerful, the server which generates the internet pages is equipped with only a small amount of working memory or has little or no hard disk space, script languages of said kind can no longer be used. This situation occurs in particular with integrated or embedded systems which are frequently encountered in the automation engineering field, for example. Embedded systems are optimized for minimum costs and generally have a simple hardware structure with slow processors and little memory, with the result that the resources required for script languages cannot be held in reserve.

DE 10 2004 036 976 A1 describes a method for dynamically generating internet pages in which the requirement for hardware resources is low and which therefore is also suited to use in embedded systems. According to DE 10 2004 036 976 A1, a static internet page is provided for a client, with variable content components providing a supplement to the static internet page. The supplementary part is created using a standard parser, a data file and a template. In this arrangement the static internet page links to the data and the latter itself to the template. Alternatively the internet page points both to the data file and to the template. However, the method has the disadvantage that the client must parse the static internet page as well as the template and the data file in order to generate therefrom a target code by means of which the client can display the corresponding internet page.

The object of the invention is therefore to disclose an improved method for generating a target code from a source code of a markup language. A further object of the invention is to disclose an improved computer program product for performing the method according to the invention as well as a corresponding computer system.

The objects underlying the invention are in each case achieved by means of the features of the independent claims. Preferred embodiments and developments of the invention can be found in the respective dependent claims.

A method for generating a machine-executable target code from a source code is disclosed according to the invention. In one method step a markup language is provided. The markup language has a first set of commands, wherein commands from the first set of commands are provided for generating templates. In a further method step the source code is input in the markup language, with templates to be generated being incorporated into the source code by means of the commands from the first set of commands and in addition data records for the templates to be generated being incorporated into the source code. In a further step, at least one table is generated from the source code, the at least one table describing the templates specified in the source code by means of the commands from the first set of commands and the data records incorporated into the source code. The target code is also generated in a programming language from the at least one table.

The commands from the first set of commands correspond to generation rules for templates. In this case the commands are preferably based on the same programming paradigms as the standard commands of the markup language. This enables a developer to write the source code in the markup language with which he/she is familiar and control the generation of templates via the commands without having to program templates directly. This saves the programmer the need to familiarize himself/herself with new programming paradigms for templates without having to forego the advantages of templates

Furthermore, the programming language is a programming language which can be executed directly by a machine. This enables the target code to be made available also to a less powerful machine and be displayed by the latter by means of a web browser without the machine itself being required to interpret the source code.

According to one embodiment of the invention the markup language has a second set of commands, wherein commands of the second set of commands are provided for the purpose of incorporating the data records. The commands from the second set of commands are language elements by means of which data records can be incorporated into the source code.

According to one embodiment of the invention the target code is generated from the at least one table on a server and transferred to a client, the programming language being a programming language which can be executed by the client. The server can be, for example, an embedded system or, as the case may be, a controller for an automation system which is associated with the client.

According to one embodiment of the invention the at least one table is generated from the source code on a configuration computer and transferred to the server. The configuration computer is typically a configuration computer for an automation system and the server is a controller or, as the case may be, an embedded system for the automation system.

Embedded systems are optimized for minimum cost and employ a generally simplified hardware structure with slow processors having little memory, wherein the hardware is required to operate with maximum reliability. Taking this into account, embedded systems of said kind cannot maintain the resources required for interpreting a markup language. In order to ensure that embedded systems can nonetheless display the content of the source code, the tables generated from the source code are, according to the invention, transferred to the server, with the result that henceforth the server will be required to generate the target code from the tables only at the request of the client, for which purpose significantly fewer resources are needed since the server no longer has to parse the source code.

The source code is preferably generated by the server from the at least one table only at the request of the client. This has the advantage that it is always the latest data incorporated into the source code via the data records that is fed into the target code.

According to one embodiment of the invention the markup language is HTML, SGML or XML or a programming language derived therefrom that has been extended by the first and second command sets.

According to one embodiment of the invention a template that is to be generated is incorporated into the source code via a command from the first set of commands, wherein a data record for the template is incorporated into the source code by means of a command from the second set of commands, the data record having a list of variable structures and the template possessing a list of values corresponding hereto.

According to one embodiment of the invention a template that is to be generated is incorporated into the source code via a command from the first set of commands, wherein a data record for the template is incorporated into the source code by means of a command from the second set of commands, wherein the data record has addresses and/or names for variables or constants, wherein the template has a variable structure, and wherein the variable structure is replaced by the addresses and/or names in the data record.

The data record can e.g. directly contain the data that is to be displayed using the corresponding template by the internet page that is generated by means of the target code. Alternatively, the data record can contain only the names or (memory) addresses of data that is stored on the server. During the generation of the target code from the at least one table the data is incorporated into the target code by means of the addresses or names by the server and displayed by the client.

According to one embodiment of the invention the commands from the first set of commands are markup commands. In this case the commands for incorporating the templates are used by the programmer in the same way as the tags predefined by default in the markup language. This ensures that the programmer does not have to learn any new programming paradigms.

According to one embodiment of the invention a markup command is composed of a start markup command and an end markup command. In addition, the type and/or name of the template that is to be generated via the command are/is specified in the start markup command and in the end markup command. The start markup command and the end markup command can also enclose a content, the template or the data that is to replace the variable structures in the template being specified in greater detail by means of the content.

In another aspect the invention relates to a computer program product having computer-executable instructions, the instructions being embodied in such a way that the method according to the invention can be performed by means of a computer system.

In a further aspect the invention relates to a computer system for performing the method according to the invention.

According to one embodiment of the invention the computer system is part of an automation system and includes a controller and a client as well as a configuration computer for the automation system.

Preferred embodiments of the invention are explained in more detail below with reference to the drawings, in which:

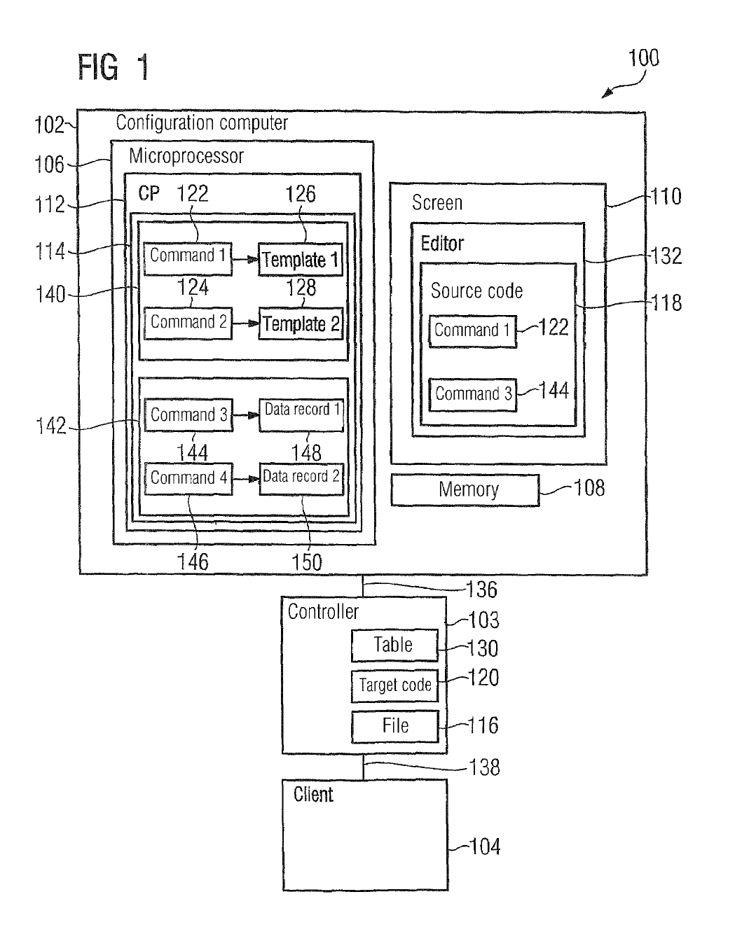

FIG. 1 shows a block diagram of a computer system,

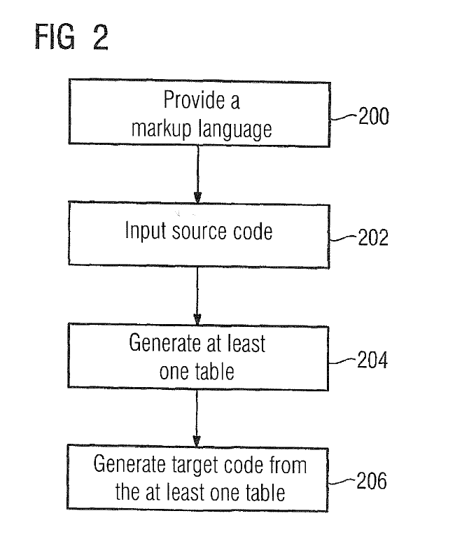

FIG. 2 is a flowchart showing steps in the method according to the invention,

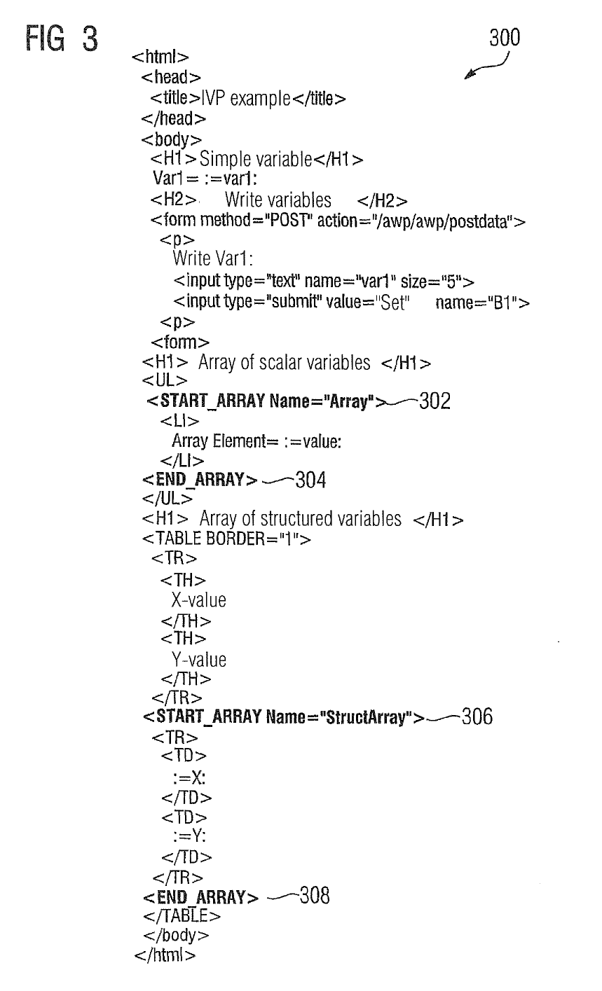

FIG. 3 shows a source code,

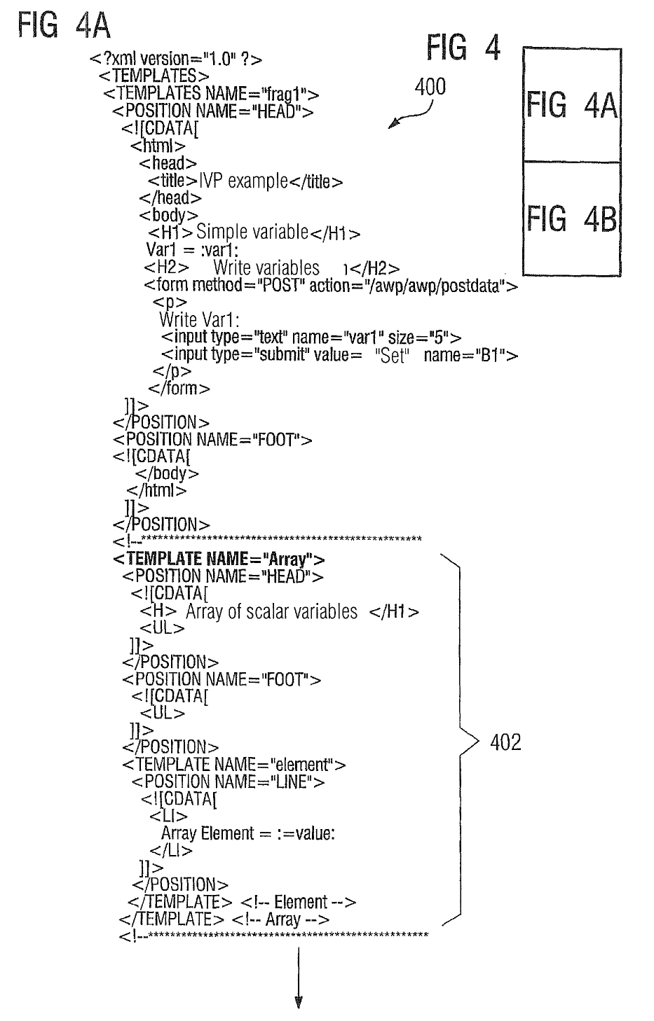

FIG. 4 shows a textual representation of the target code generated from the source code,

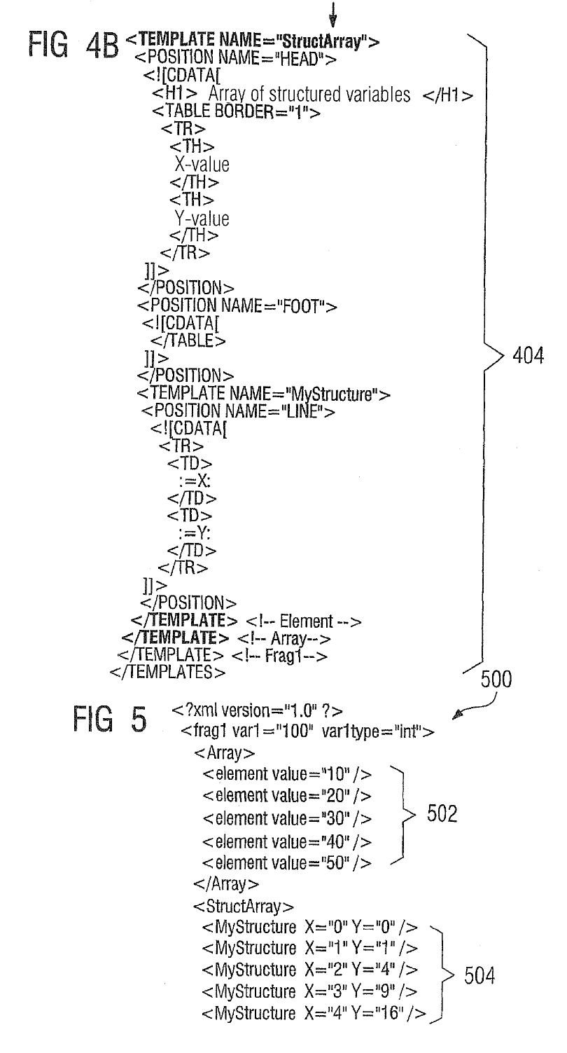

FIG. 5 shows a file in which values for a template incorporated in the source code are kept available, and

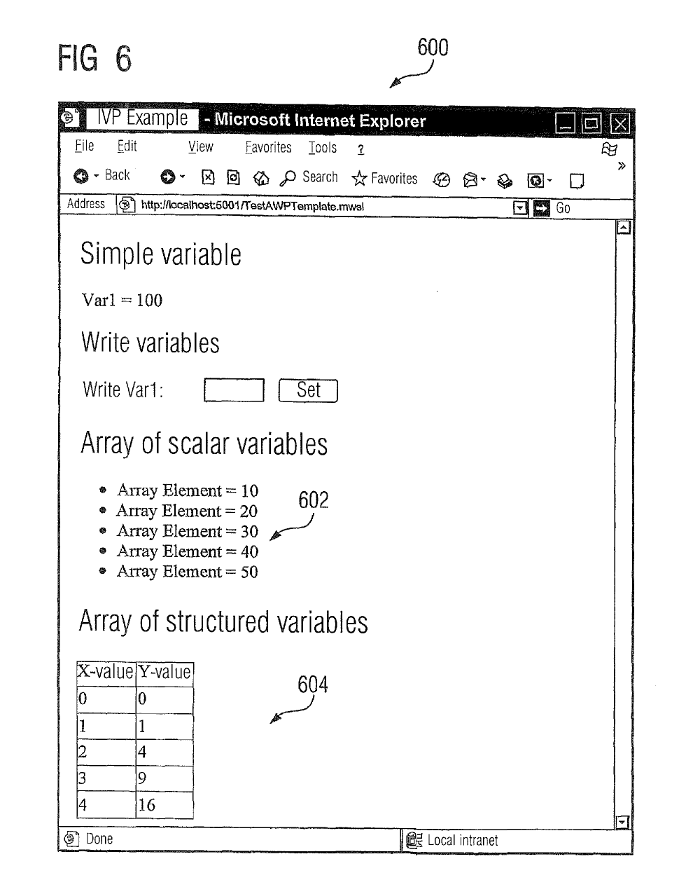

FIG. 6 shows an output of the target code generated by means of a browser.

FIG. 1 shows a block diagram of a computer system 100 having a configuration computer 102, a controller 103 and a client 104. The configuration computer 102 and the controller 103 are connected via a communications link 136. The client 104 and the controller 103 are connected via a communications link 138. The configuration computer 102 has a microprocessor 106, a memory 108 and a screen 110. The microprocessor 106 executes a computer program 112 which is permanently resident in the memory 108 and has been loaded into the microprocessor 106 for execution.

A markup language 114 is provided with the computer program 112, a source code 118 written in the markup language 114 being convertible into a target code 120 of a programming language. Also predefined in the markup language 114 is a first set of commands 140, the templates 126, 128 being able to be generated by means of the commands 122, 124 from the set of commands. In addition, data records can be incorporated into the source code by means of a second set of commands 142 which includes the commands 144, 146. For example, the data record 148 can be incorporated into the source code using the command 144 and the data record 150 can be incorporated by means of the command 146.

Shown in the screen 110 is an editor 132 into which a programmer inputs the source code 118 in the markup language 114 using a keyboard which is not shown here. In order to generate, for example, the template 126 via the source code 118, the programmer does not now program the template 126 directly, but instead uses the command 122 in the source code 118. In this case the command 122 corresponds to a generation rule for the template 126, the command 122 being based here on the same programming paradigms as the standard commands predefined in the markup language 114. This has the advantage that the programmer does not now have to be concerned with the programming paradigms on which the template is based. Rather, he/she can use the command 122 in the way familiar to him/her from the use of the markup language 114 in order to incorporate the template 126 into the source code.

Furthermore, the data record 148 for the template 126 is also incorporated into the source code 118 via the command 144.

After the source code 118 has been input, the parsing of the source code 118 by the computer program 112 is initiated by the programmer and a table 130 is generated which describes the template 128 specified by means of the command 122 together with the data record 148 incorporated by means of the command 144. The table 130 is then transmitted via the communications link 136 to the controller 103, where the target code 120 is generated in the programming language by the controller from the table 130. At the same time variables or constants specified via their addresses or names in the data record are replaced as necessary by the corresponding values which are kept available in a file 116 on the controller 103.

The programming language is, for example, a language which is directly executable by the client 104 (on a microprocessor (not shown here) of the client). The target code 120 can therefore be requested from the client 104 via the communications link 138 and displayed by the client 104 for example by way of a screen (not shown here).

FIG. 2 is a flowchart showing steps of the inventive method for generating a machine-executable target code from a source code. In step 200, a markup language is provided, wherein the markup language has a first set of commands, commands from the first set of commands being provided for generating templates, and wherein the markup language has a second set of commands, commands from the second set of commands being provided for incorporating data records. In step 202, the source code is input in the markup language, templates that are to be generated being incorporated into the source code by means of the commands from the first set of commands and data records for templates that are to be generated being incorporated into the source code by means of commands from the second set of commands. In step 204, at least one table is generated from the source code, the at least one table describing the templates specified in the source code by means of the commands from the first set of commands and the data records incorporated into the source code by means of the commands from the second set of commands. In step 206, the target code is generated in addition in a programming language from the at least one table.

FIG. 3 shows a source code 300 which has been written in HTML. A markup command comprising a start markup command 302 (<START_ARRAY ..>) and an end markup command 304 has been used in the source code 300 in order to generate a template with the name “Array”. In addition, the command comprising a start markup command 306 and an end markup command 308 represents a generation rule for a template with the name “StructArray”.

By means of the content enclosed between the start markup command 302 and the end markup command 304, the programmer can specify in greater detail in the code which values are to be copied into the template to be generated, the programmer being able to use e.g. the tags <LI>, </LI> familiar to him/her from HTML. Furthermore, values for variable structures, i.e. for the variable “value” in the template “Array” can be specified by way of the entry Array Element=:=value. The values for the variable “value” are in this case stored in a separate file which is shown in FIG. 5. In the narrower sense the command “:=” is a command from the aforementioned second set of commands, an assignment Array Element→value being implemented via said command. In the wider sense the command “Array Element=:=value” is a command from the second set of commands.

By means of the content enclosed between the start markup command 306 and the end markup command 308 the programmer can also specify which values (X-value:=X; Y-value:=Y) that are predefined in a separate file (cf. FIG. 5) are to be included in the template that is to be generated in accordance with the commands 306 and 308. In this case the programmer can also use the tags familiar to him/her, such as e.g. <TR> or <TD>. Accordingly, he/she does not need to familiarize himself/herself with paradigms on which template programming is based, but can incorporate templates defined by way of the commands into the source code 300.

FIG. 4 shows a textual representation of the target code 400 generated from the source code 300, the tables having been generated in an intermediate step. The actual target code 400 cannot be displayed as it is present in binary form because, of course, it is directly machine-executable. Essentially, the start markup commands 302, 306 and end markup commands 304, 308 (cf. FIG. 3) together with the content enclosed by them have been replaced in the target code 400 by the templates 402 and 404. In this case the start markup commands 302, 306 and the end markup commands 304 and 308 have been replaced during parsing of the source code 300 for the purpose of generating the corresponding templates by the command <TEMPLATE ..> and </TEMPLATE>, respectively, and the content between the markup commands has been copied essentially between the commands <TEMPLATE ..> and </TEMPLATE>.

FIG. 5 shows a file 500 in text form in which values 502, 504 for variable structures of templates are predefined. In this case the values 502 relate to the variable “value” listed in the aforementioned template with the name “Array” and are specified with 10, 20, 30, 40 and 50. The values 504 relate to the variables “X” and “Y” used in the aforementioned template “StructArray” and in this case are specified with (X=0, Y=0), (X=1, Y=1), (X=2, Y=4), (X=3, Y=9), (X=4, Y=16) respectively.

FIG. 6 shows the browser-generated output 600 of the target code 400 (cf. FIG. 4). In this case the template generated via the start markup command 302 and the end markup command 304 (cf. FIG. 3) in the area 602 of the output 600 is displayed with the values 502 specified in the file 500 for the variable “value”. The table generated via the start markup command 306 and end markup command 308 with the values predefined for the variable “X” and “Y” in the file 500 is correspondingly shown in the area 604 of the output. Finally, therefore, by means of the source code 300, a target code that is displayable by means of a browser can be generated in the templates using only commands that are written in the markup language on which the source code 300 is based, without the templates having to be programmed directly.

1.-23. (canceled)

24. A method for generating a machine-executable target code from a source code, comprising the steps:
providing a markup language having a first set of commands,
selecting commands from the first set of commands for generating templates,
inputting the source code in the markup language,
incorporating into the source code templates to be generated with the commands from the first set of commands,
incorporating into the source code data records for the templates,
generating at least one table from the source code, wherein the at least one table describes the templates incorporated in the source code with the commands from the first set of commands and the data records incorporated into the source code, and
generating from the at least one table the target code in a programming language.

25. The method of claim 24, wherein the markup language has a second set of commands, said commands from the second set of commands being provided for incorporating the data records into the source code.

26. The method of claim 24, wherein the target code is generated from the at least one table on a server and transferred to a client, with the programming language being executable by the client.

27. The method of claim 26, wherein the at least one table is generated from the source code on a configuration computer, and wherein the at least one table is transferred to the server.

28. The method of claim 27, wherein the at least one table is transmitted from the server to the client upon request by the client, and wherein the at least one table is generated only after the request by the client has been received.

29. The method of claim 25, wherein the data records have a list of variable structures, and wherein the templates comprise a list of values corresponding the list of variable structures.

30. The method of claim 25, wherein the data records have addresses and/or names for variables or constants, wherein the templates have a variable structure, and wherein the variable structure is replaced by the addresses and/or names in the data records.

31. The method of claim 24, wherein the markup language is HTML, SGML or XML or a programming language derived therefrom.

32. The method of claim 24, wherein the commands from the first set of commands are markup commands.

33. The method of claim 32, wherein a markup command is composed of a start markup command and an end markup command, with the start markup command and the end markup command defining a type and/or a name of a template to be generated with the markup command.

34. The method of claim 32, wherein a markup command is composed of a start markup command and an end markup command, with the start markup command and the end markup command including content which specifies in greater detail the template to be generated with the markup command.

35. A computer program product embodied in a computer-readable medium which is loaded directly into a memory of a computer and includes computer-executable instructions, wherein the instructions, when executed by the computer, cause the computer to:
provide a markup language having a first set of commands,
select commands from the first set of commands for generating templates,
input the source code in the markup language,
incorporate into the source code templates to be generated with the commands from the first set of commands,
incorporate into the source code data records for the templates,
generating at least one table from the source code, wherein the at least one table describes the templates incorporated in the source code with the commands from the first set of commands and the data records incorporated into the source code, and
generate from the at least one table the target code in a programming language.

36. A computer system comprising:
means for providing a markup language having a first set of commands,
means for selecting commands from the first set of commands for generating templates,
means for inputting the source code in the markup language,
means for incorporating into the source code templates to be generated with the commands from the first set of commands,
means for incorporating into the source code data records for the templates,
means for generating at least one table from the source code, wherein the at least one table describes the templates incorporated in the source code with the commands from the first set of commands and the data records incorporated into the source code, and
means for generating from the at least one table the target code in a programming language.

37. The computer system of claim 36, wherein the markup language has a second set of commands, said commands from the second set of commands being provided for incorporating the data records into the source code.

38. The computer system of claim 36, wherein the target code is generated from the at least one table on a server and transferred to a client, with the programming language being executable by the client.

39. The computer system of claim 36, wherein the at least one table is generated from the source code on a configuration computer, and wherein the at least one table is transferred to the server.

40. The computer system of claim 39, wherein the target code is transmitted from the server to the client upon request by the client, and wherein the target code is generated from the at least one table only after the request by the client has been received.

41. The computer system of claim 35, wherein a data record has a list of variable structures, and wherein the template comprises a list of values corresponding the list of variable structures.

42. The computer system of claim 35, wherein the data record has addresses and/or names for variables or constants, wherein the template has a variable structure, and wherein the variable structure is replaced by the addresses and/or names in the data record.

43. The computer system of claim 35, wherein the markup language is HTML, SGML or XML or a programming language derived therefrom.

44. The computer system of claim 35, wherein the commands from the first set of commands are markup commands.

45. The computer system of claim 44, wherein a markup command is composed of a start markup command and an end markup command, with the start markup command and the end markup command defining a type and/or a name of a template to be generated with the markup command.

46. The computer system of claim 44, wherein a markup command is composed of a start markup command and an end markup command, with the start markup command and the end markup command including content which specifies in greater detail the template to be generated with the markup command.
